(19) United States
(12) Patent Application Publication
(10) Pub. No.: US 2004/0140723 A1
(43) Pub. Date: Jul. 22, 2004

(54) Electric motor

(75) Inventor: Herbert Severien, Linsengericht (DE)

Correspondence Address: SIEMENS SCHWEIZ, I-44, INTELLECTUAL PROPERTY, ALBISRIEDERSTRASSE 245, ZURICH, CH-8047, CH

(73) Assignee: SIEMENS AG, MUNICH (DE)

(21) Appl. No.: 10/753,433

(22) Filed: Jan. 9, 2004

Related U.S. Application Data
(63) Continuation of application No. PCT/DE02/02214, filed on Jun. 18, 2002.

(30) Foreign Application Priority Data
Jul. 20, 2001 (DE) 101 34 689.1

(51) Int. Cl. H02K 5/16; H02K 7/08

(52) U.S. Cl. 310/90; 384/119; 384/130

(57) ABSTRACT

The present invention relates to an electric motor having a housing. The housing includes an internal chamber in which the rotor is mounted with its shaft in at least one bearing. An aim of the invention is to provide an electric motor whose housing includes an internal chamber, at least one part of which is sealed in a particularly reliable manner against the external chamber of the housing. To achieve this, one area of the housing has a stepped bore in which a seal is located, through which the shaft of the rotor projects out of the housing. The stepped bore has a first diameter with a first dimension and a second diameter with a second dimension, the first dimension being greater than the second dimension.

The present invention is a continuation of International Application No.: PCT/DE02/02214, filed 18 Jun. 2002, which claimed the United States, and claims priority to priority application No.: DE10134689.1, filed 20 Jul. 2001; the both of which are herein incorporated by reference.

### BACKGROUND OF THE INVENTION

The invention relates to an electric motor with a housing, the housing having an inner space, in which the rotor is mounted with its shaft in at least one bearing.

Electric motors are used today, both as electrically commutated and as mechanically commutated electric motors, in the most diverse possible applications throughout the world. In this context, it is most often intended to drive to some extent with its shaft mounted in a fluid, for example oil. For this purpose, conventionally, the orifice through which the shaft of the rotor of the electric motor is led out of the housing is protected against the penetration of fluid by means of a seal.

When the electric motor is in operation, the air in the inner space of the housing of the electric motor heats up. The result of this is that the air enclosed in the housing of the electric motor expands adiabatically. This adiabatic expansion of the air in the inner space of the housing of the electric motor has the effect of pressing the seal outward out of the housing of the electric motor. On the other hand, fluid tends to creep into the inner space of the housing of the electric motor. In this case, the pressure of the fluid may also be such that the fluid presses the seal into the housing of the electric motor. For these reasons, normally, an electric motor, the shaft of which is provided for driving a device arranged partially in a fluid, usually has a particularly short useful life.

### SUMMARY OF THE INVENTION

An object on which the invention is based is, therefore, to specify an electric motor of the abovementioned type, the housing of which has an inner space which, at least at one point, is protected particularly reliably against the egress of the seal and the penetration of fluid.

This object is achieved, according to the invention, in that the housing has an approximately step-shaped bore, in which is arranged a seal through which the shaft of the rotor projects out of the housing, the step-shaped bore having a first diameter with a first dimension and a second diameter with a second dimension, and the first dimension being greater than the second dimension.

The invention thus proceeds from the consideration that the inner space of the housing of the electric motor is protected especially reliably against an egress of the seal from the housing when the seal is arranged in the housing in such a way that a mechanical egress of the seal from the housing is reliably prevented. This is reliably ensured when the housing has a mechanical barrier, by means of which the seal is secured reliably in the housing. A barrier of this kind is an approximately step-shaped bore which either narrows in a step-shaped manner in a direction of the outer space of the housing or, alternatively, narrows both toward the inner space of the housing and toward the outer space of the housing. This step-shaped bore is to have arranged in it a seal which, due to the form of the approximately step-shaped bore, assumes different diameters in the various bore steps.

Advantageously, the seal is manufactured predominantly from elastomeric material. Elastomeric material ensures especially reliably that the seal is compressed and, on the other hand, expands in the individual bore steps.

Advantageously, the seal completely surrounds a steel reinforcement. The steel reinforcement gives the seal sufficient strength, so that, even when used for particularly long periods of time, it keeps its shape approximately unchanged.

Advantageously, the seal radially surrounds, with a sealing lip, a worm spring. The worm spring is in this case designed in such a way that it presses the sealing lip of the seal against the shaft of the rotor of the electric motor. As a result, even when the seal is used for particularly long periods of time, it is ensured especially reliably that the seal bears closely with its sealing lip against the outer circumference of the shaft of the rotor of the electric motor.

Advantageously, the electric motor can be used in a valve drive of an internal combustion engine of a motor vehicle. The valve drive of an internal combustion engine of a motor vehicle is conventionally arranged at least partially in an oil bath. The abovementioned electric motor is particularly suitable for this purpose, since, by virtue of its design, a penetration of oil into the inner space of the housing of the electric motor is reliably prevented and, at the same time, an egress of the seal from the housing of the electric motor is reliably avoided.

The advantage is achieved by means of the invention are, in particular, that the form fit of seals, that is to say rubber moldings, in bores is reliably ensured. This applies even when pressure rises of the air in the inner space of the housing occur and/or pressure changes in the outer space of the housing occur.

### BRIEF DESCRIPTION OF THE SEVERAL VIEWS OF THE DRAWINGS

An exemplary embodiment of the invention is explained in more detail by means of a drawing in which:

FIG. 1 shows diagrammatically a motor vehicle of an internal combustion engine,

FIG. 2 shows diagrammatically a detail of an electric motor which has a housing with a bore, through which the shaft of the rotor is led out of the inner space of the housing into the outer space of the housing,

FIG. 3 shows diagrammatically the detail A from FIG. 2 with the seal which seals off the inner space of the housing of the electric motor relative to the outer space.

### DETAILED DESCRIPTION OF THE INVENTION

Parts corresponding to one another are given the same reference symbols in all the figures.

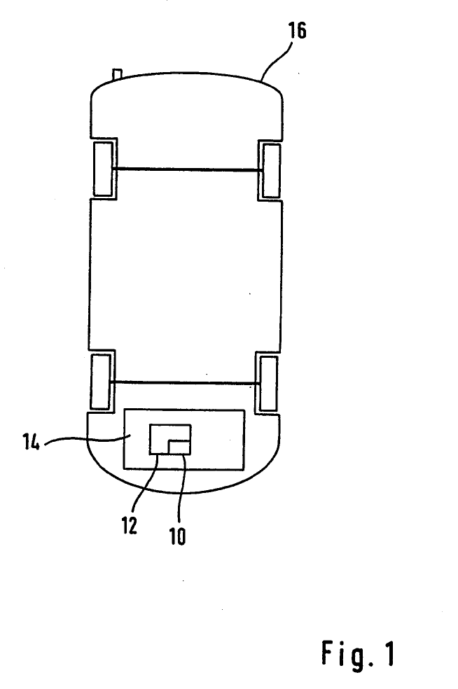

The electric motor 10 according to FIGS. 1 to 3 is arranged, according to FIG. 1, in a valve drive 12 of the internal combustion engine 14 of a motor vehicle 16. The valve drive 12 is provided for opening and closing a valve, a closing member. The valve is in this case arranged in the cylinder head of an internal combustion engine. The valve and the cylinder head are not illustrated in any more detail in the drawing.

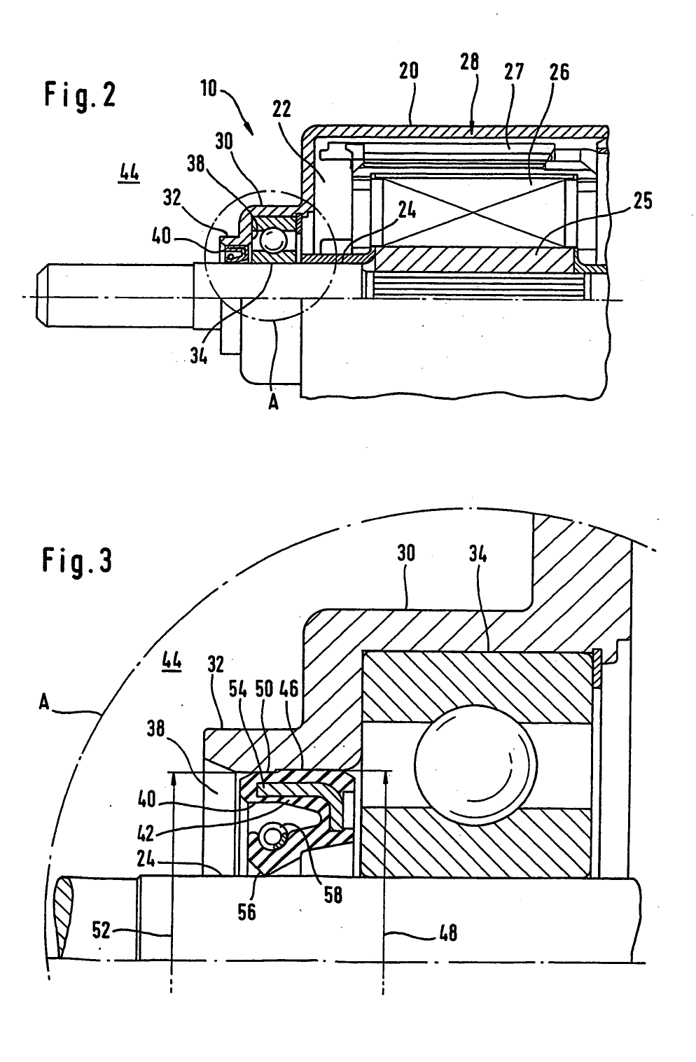

FIG. 2 shows a detail of the electric motor 10. The electric motor 10 has a housing 20 with an inner space 22. In the inner space 22 of the housing 20 is arranged a shaft 24 which, inter alia, forms with the armature 25 the rotor 26 of the electric motor 10.

Permanent magnets 27 are arranged on the inner wall of the housing 20. The permanent magnets 27 form inter alia, with the housing 20, the stator 28 of the electric motor 10.

In the illustrated detail of the electric motor 10, there can be seen that region of the housing 20 of the electric motor 10 in which the shaft 24 of the electric motor 10 is led out of the inner space 22 of the housing 20. For this purpose, the housing 20 of the electric motor 10 narrows in this region of the housing 20 approximately in a step-shaped manner into a first portion 30 and a second portion 32. The outer circumference of the first portion 30 of the housing 20 is in this case larger than the outer circumference of the second portion 32 of the housing 20.

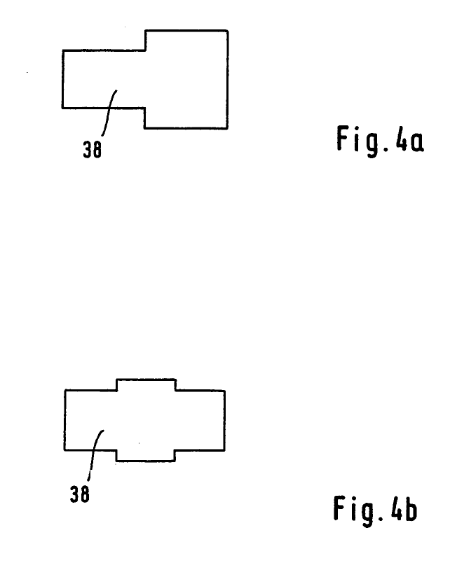

The first portion 30 of the housing 20 has arranged in it a bearing 34 which is designed as a grooved ball bearing and in which the shaft 24 of the electric motor 10 is mounted. Conventionally, the shaft 24 of the electric motor 10 is also mounted at a second point, this not being illustrated in any more detail in the drawing. The second portion 32 of this region of the housing 20 has an approximately step-shaped bore 38 in which a seal 40 is arranged. The seal 40 is manufactured from elastomeric material 42. The seal 40 is in this case designed as a radial shaft sealing ring with an outer contour comprising elastomeric material 42. This seal 40 closes off the inner space 22 of the housing 20 of the electric motor 10 hermetically relative to the outer space 44 of the housing 20. The seal 40, which is designed as a radial shaft sealing ring, is arranged in the housing 20 of the electric motor 10 in such a way that, in the event of a pressure rise of the air located in the inner space 22 of the housing 20 of the electric motor 10, the seal 40 is not pressed out of the housing 20 of the electric motor 10. The arrangement allowing this egress of the seal 40 is arranged in the region A of FIG. 2 and is shown in detail in FIG. 3.

According to FIG. 3, the seal 40 is arranged in an approximately step-shaped bore 38. The approximately step-shaped bore 38 in this case has a first diameter 46 or a first step with a first dimension 48. Furthermore, the approximately step-shaped bore 38 has a second diameter 50 or a second step with a second dimension 52. In this case, the first dimension 48 is greater than the second dimension 52. The second dimension 52 in this case faces the outer space 44 of the housing 20. The first dimension 48 of the step-shaped bore 38 is arranged between the second diameter 50 of the approximately step-shaped bore 38 and the bearing 34.

The seal 40 is pressed into the housing 20 during the manufacture of the electric motor 10. In this case, the seal 40 is compressed by the second dimension 52 of the second diameter 50 of the step-shaped bore 38. As the seal 40, as it is pressed into the housing 20 of the electric motor 10, reaches into the region of the first diameter 46 with the first dimension 48 of the step-shaped bore 38, the seal 40 relaxes and has a larger outer circumference in the first diameter 46 of the step-shaped bore 38 than in the second diameter 50 of the step-shaped bore 38. This difference in diameter of the seal 40 on account of the predetermined form of the step-shaped bore 38 has the effect that the seal 40 can no longer be pushed out of the sealing well by the pressure forces building up in the inner space 22 of the housing 20 on account of temperature changes.

So that the seal 40 keeps its shape constantly even over particularly long periods of time, the seal 40 has a steel reinforcement 54 which is surrounded by the seal 40 and has an approximately annular design. This steel reinforcement 54 reliably ensures a dimensional stability of the seal 40 in the direction of the housing 20.

Furthermore, the seal 40 comprises a sealing lip 56 which is pressed against the shaft 24 of the electric motor 10 by a worm spring 58. In this case, a seal 40 surrounds the worm spring 58 radially in such a way that a part region of the worm spring 58 is not surrounded by the elastomeric material 42 of the seal 40. As a result, a particularly good sealing of the seal 40 in the direction on the shaft 24 of the rotor 26 of the electric motor 10 is reliably ensured even over particularly long periods of time.

The profile of the approximately step-shaped bore 38 shown in FIG. 3 is shown in FIG. 4a. Alternatively to the profile of the approximately step-shaped bore according to FIG. 3, the approximately step-shaped bore 38 may have a profile which narrows both toward the inner space 20 of the housing and toward the outer space 44 of the housing 20 as illustrated in FIG. 4b. The profile of the approximately step-shaped bore according to FIG. 4b reliably ensures that, in the absence of high external forces, the seal 40 arranged in the bore 38 does not creep either into the housing 20 or out of the housing 20.

By the seal 40 being arranged in the step-shaped bore 44 of the housing 20 of the electric motor 10, the seal 40 reliably closes off the housing 20 of the electric motor 10 hermetically relative to the outer space 44 of the housing 20 even when pressure changes of the air due to temperature changes occur in the inner space 22 of the housing 20.

We claim:

1. An electric motor, comprising:
a housing comprising an approximately step-shaped bore having a first diameter with a first dimension and a second diameter with a second dimension, said first dimension being greater than said second dimension;
a seal arranged within said bore; and
a rotor including a bearing mounted shaft, said rotor mounted within said housing such that said shaft projects out of said housing and through said seal.

2. The electric motor according to claim 1, wherein said seal comprises elastomeric material.

3. The electric motor according to claim 1, wherein said seal accommodates a steel reinforcement therein.

4. The electric motor according to claim 2, wherein said seal accommodates a steel reinforcement therein.

5. The electric motor according to claim 1, further comprising a worm spring located adjacent to said seal, and wherein said seal comprises a sealing lip substantially surrounding said worm spring.

6. The electric motor according to claim 2, further comprising a worm spring located adjacent to said seal, and wherein said seal comprises a sealing lip substantially surrounding said worm spring.

7. The electric motor according to claim 3, further comprising a worm spring located adjacent to said seal, and wherein said seal comprises a sealing lip substantially surrounding said worm spring.

8. The electric motor according to claim 4, further comprising a worm spring located adjacent to said seal, and wherein said seal comprises a sealing lip substantially surrounding said worm spring.

9. The electric motor according to claim 1, wherein said first dimension is located at one end of said bore and said second dimension is located at the other end of said bore.

10. The electric motor according to claim 1, wherein said second dimension is located at ends of said bore and said first dimension is located between adjacent second dimensions.

11. The electric motor according to claim 1, wherein said motor comprises an internal chamber within which said rotor is mounted.

12. The electric motor according to claim 1, wherein said shaft is mounted on at least one bearing.
